(19) United States
(12) Patent Application Publication
(10) Pub. No.: US 2013/0281216 A1
(43) Pub. Date: Oct. 24, 2013

(54) NON-TRANSITORY COMPUTER-READABLE STORAGE MEDIUM, GAME APPARATUS, GAME SYSTEM, AND GAME PROCESSING METHOD

(71) Applicant: NINTENDO CO., LTD., Kyoto (JP)

(72) Inventors: Teruyuki SHIMOYAMADA, Tokyo (JP); Toru NAGIHASHI, Tokyo (JP)

(73) Assignee: NINTENDO CO., LTD., Kyoto (JP)

(21) Appl. No.: 13/793,411

(22) Filed: Mar. 11, 2013

(30) Foreign Application Priority Data
Apr. 20, 2012 (JP) 2012-096762

(51) Int. Cl. A63F 13/12

(52) U.S. Cl. CPC A63F 13/12
USPC 463/42

(57) ABSTRACT

In a game in which a game character in a game world is trained, a passerby corresponding to another player is caused to appear in a shopping center in the game world, in response to that other player information is received from an information processing apparatus owned by the another player. Further, a facility such as a training facility that trains the game character on behalf of the player appears in the shopping center, in response to that a player character operated by the player persuades the passerby.

### CROSS REFERENCE TO RELATED APPLICATION

The disclosure of Japanese Patent Application No. 2012-096762, filed on Apr. 20, 2012, is incorporated herein by reference.

### FIELD

The technology disclosed herein relates to a non-transitory computer-readable storage medium, a game apparatus, a game system, and a game processing method, and more particularly, to those utilizing a communication function.

### BACKGROUND AND SUMMARY

Conventionally, a system has been known in which an apparatus performs an automatic communication with another apparatus that is present in a communicable range, and thereby a character registered in the another apparatus is caused to appear in the apparatus.

A main object of the present technology is to provide a non-transitory computer-readable storage medium, a game apparatus, a game system, and a game processing method, which are capable of activating communication between game apparatuses (or between information processing apparatuses each executing a game program).

The above object is achieved by configuration examples as follows.

A first configuration example is a non-transitory computer-readable storage medium having stored therein a game program for causing a computer of an information processing apparatus connected to an input device and a communication device to execute: a first training process of training a game character in a game world, based on an operation performed by a player on the input device; a reception process of receiving predetermined data from an information processing apparatus of another player via the communication device; and a training support process of activating a substitute training function capable of training the game character without depending on the first training process, or enhancing efficiency of training by the first training process, on at least a requirement that the predetermined data has been received by the reception process.

The input device may be any input device such as a button, an analog stick, a touch panel, a mouse, or a key board.

The communication device may receive the predetermined data via a communication cable, or by wireless communication (e.g., wireless LAN, short-range wireless communication, infrared communication, or the like). Further, the communication device may receive the predetermined data from the information processing apparatus of the another player via a network such as the Internet, a server device, or the like.

The information processing apparatus may be any information processing apparatus such as a hand-held game apparatus, stationary game apparatus, personal digital assistant, mobile phone, laptop computer, or desktop computer.

The game character may be a character (player character) directly operated by the player, or a virtual friend creature or the like owned by the player character.

Training of the game character by the first training process is typically performed by causing the game character to fight with an enemy character, and increasing, according to the result of the fight, game parameters indicating various abilities of the game character (e.g., level, physical strength, offensive power, defensive power, quickness, etc.).

The predetermined data may be data including at least one piece of predetermined information (e.g., identification information of another information processing apparatus having transmitted the predetermined data, identification information of a player of the another information processing apparatus, information registered in the another information processing apparatus by the player thereof, or the like), or may be arbitrary data (any data).

The substitute training function is typically a function of increasing the game parameters indicating the various abilities of the game character, in exchange for points that the player has gained in the game (e.g., currency in the game world, items such as medals, or the like).

In the training support process, the substitute training function may be activated by causing a facility that provides the substitute training function to appear in the game world, or by enabling the player to call the substitute training function from a menu screen. Further, the efficiency of training of the game character by the first training process may be enhanced by setting the experience points that the player can gain when the game character defeats the enemy character, higher than usual. Alternatively, the efficiency of training of the game character by the first training process may be enhanced by setting the probability of increase or the degree of increase of the game parameters indicating the various abilities of the game character (e.g., level, physical strength, offensive power, defensive power, quickness, etc.), higher than usual.

The training support process may include: a substitute training function activating process of activating the substitute training function capable of training the game character without depending on the first training process, on at least a requirement that the predetermined data has been received by the reception process; and a second training process of training the game character by the substitute training function.

Training of the game character by the second training process is typically performed by increasing the game parameters indicating the various abilities of the game character by the substitute training function.

In the substitute training function activating process, the substitute training function may be activated by causing a training facility capable of training the game character without depending on the first training process to appear in the game world.

The game program may cause the computer to further execute a point giving process of giving predetermined points to the player in accordance with an operation performed by the player on the input device. In the second training process, the game character may be trained by the substitute training function, in exchange for a predetermined number of points given to the player by the point giving process.

The substitute training function activating process may include a determination process of determining, based on a predetermined rule, whether the substitute training function is to be activated, in response to that the predetermined data has been received by the reception process. In the substitute training function activating process, the substitute training function may be activated only when a result of the determination of the determination process is positive.

In the determination process, whether the substitute training function is to be activated may be determined based on the predetermined data received by the reception process.

The predetermined data may include function designation data that designates a function selected by the another player from among a plurality of functions including the substitute training function and other functions. In the determination process, the substitute training function may be activated only when the function designation data included in the predetermined data designates the substitute training function.

The game program may cause the computer to further execute a substitute training function development process of developing the substitute training function, on at least a requirement that the predetermined data has been received from an information processing apparatus of still another player by the reception process, in a state where the substitute training function has already been activated by the substitute training function activating process.

The game program may be stored in any computer-readable storage medium (e.g., a flexible disk, hard disk, optical disc, magneto-optical disc, CD-ROM, CD-R, magnetic tape, semiconductor memory card, ROM, RAM, or the like).

A second configuration example is a game apparatus connected to an input device and a communication device. The game apparatus includes: a first training section configured to train a game character in a game world in accordance with an operation performed by a player on the input device; a reception section configured to receive predetermined data from an information processing apparatus of another player via the communication device; and a training support section configured to activate a substitute training function capable of training the game character without depending on the first training section, or enhance efficiency of training by the first training section, on at least a requirement that the predetermined data has been received by the reception unit.

A third configuration example is a game system including: an input device; a communication device; a first training section configured to train a game character in a game world in accordance with an operation performed by a player on the input device; a reception section configured to receive predetermined data from an information processing apparatus of another player via the communication device; and a training support section configured to activate a substitute training function capable of training the game character without depending on the first training section, or enhance efficiency of training by the first training section, on at least a requirement that the predetermined data has been received by the reception section.

A fourth configuration example is a game processing method executed in an information processing apparatus connected to an input device and a communication device. The game processing method includes: executing a first training process of training a game character in a game world in accordance with an operation performed by a player on the input device; executing a reception process of receiving predetermined data from an information processing apparatus of another player via the communication device; and executing a training support process of activating a substitute training function capable of training the game character without depending on the first training process, or enhancing efficiency of training by the first training process, on at least a requirement that the predetermined data has been received by the reception process.

According to the present technology, it is possible to activate communication between game apparatuses (or between information processing apparatuses each executing a game program).

### BRIEF DESCRIPTION OF THE DRAWINGS

FIG. 1 is a block diagram illustrating a non-limiting example of a configuration of a game apparatus;

FIG. 2 is a diagram illustrating a non-limiting example of a game image:

FIG. 3 is a diagram illustrating a non-limiting example of a game world;

FIG. 4 is a diagram illustrating a non-limiting example of a state of a shopping center in the game world;

FIG. 5 is a diagram illustrating a non-limiting example of a manner in which a game apparatus 10a receives other player information from a game apparatus 10b;

FIG. 6 is a diagram illustrating a non-limiting example of a state of the shopping center in the game world;

FIG. 7 is a diagram illustrating a non-limiting example of a game image;

FIG. 8 is a diagram illustrating a non-limiting example of a state of the shopping center in the game world;

FIG. 9 is a diagram illustrating a non-limiting example of a state of the shopping center in the game world;

FIG. 10 is a diagram illustrating a non-limiting example of a state of the shopping center in the game world;

FIG. 11 is a diagram illustrating non-limiting examples of a computer program and data stored in a main memory; and

FIG. 12 is a flowchart illustrating a non-limiting example of a procedure of game processing executed by a processor.

### DETAILED DESCRIPTION OF NON-LIMITING EXAMPLE EMBODIMENTS

Hereinafter, one embodiment of the present technology will be described.

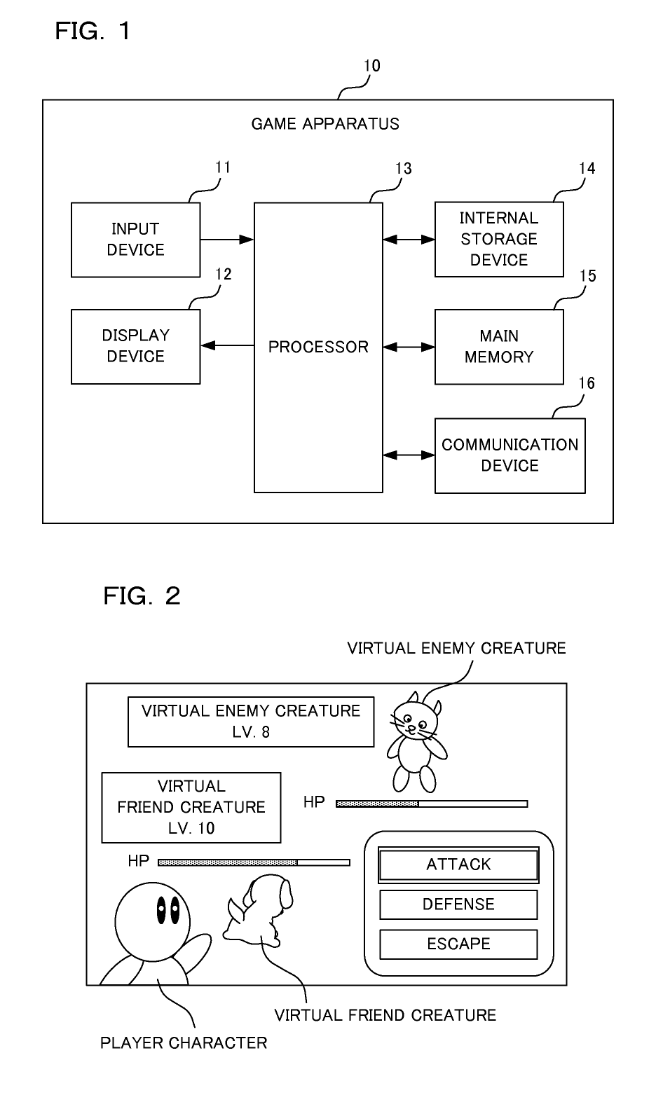

In FIG. 1, the game apparatus 10 includes an input device 11, a display device 12, a processor 13, an internal storage device 14, a main memory 15, and a communication device 16.

The input device 11 is operated by a user of the game apparatus 10, and outputs a signal according to the operation performed by the user. The input device 11 is, for example, a cross switch, a push button, or a touch panel.

The display device 12 displays, on a screen, an image generated in the game apparatus 10. The display device 12 is typically a liquid crystal display device.

A computer program to be executed by the processor 13 is stored in the internal storage device 14. The internal storage device 14 is typically a flash EEPROM.

The main memory 15 temporarily stores a computer program and data.

The communication device 16 transmits a signal to another game apparatus, and receives a signal from another game apparatus.

Next, the outline of an operation of the game apparatus 10 will be described.

The game apparatus 10 executes game processing based on a game program. In the present embodiment, a game is executed as follows. A player character operated by a player gives a command to a virtual friend creature owned by the player character to cause the virtual friend creature to fight with a virtual enemy creature, and thus the virtual friend creature is trained (i.e., the abilities of the virtual friend creature are enhanced) so that the virtual friend creature can defeat a stronger virtual enemy creature. For example, FIG. 2 shows a game image in which a virtual friend creature is fighting with a virtual enemy creature. The player can select a command to be given to the virtual friend creature, from a plurality of options (attack, defense, escape).

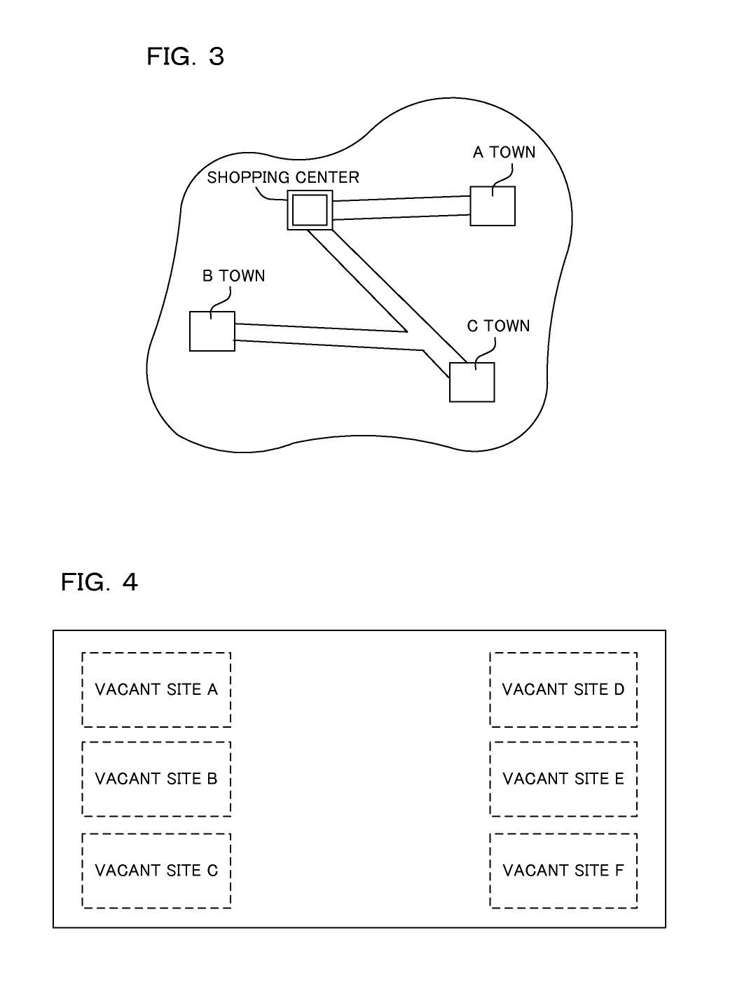

In a game world of the above-described game, a shopping center and a plurality of towns are arranged as shown in FIG. 3. Although nothing is built in the shopping center in its initial state as shown in FIG. 4, the player can develop the shopping center by building facilities in vacant sites A to F in accordance with a procedure described below. The number of the vacant sites is not limited to six.

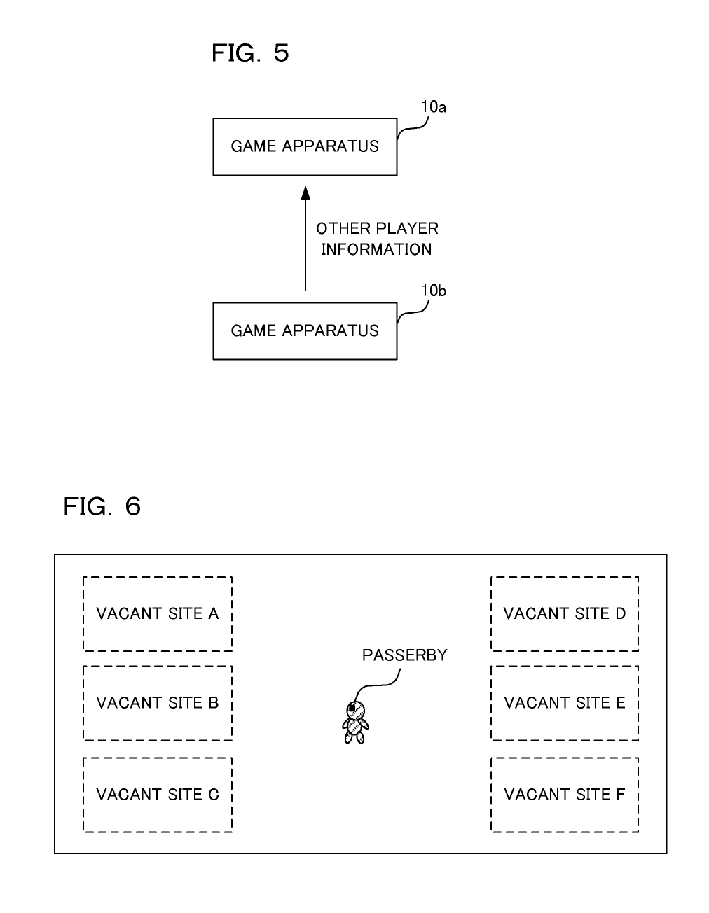

In order to develop the shopping center, the game apparatus 10 needs to receive “other player information” from another game apparatus as shown in FIG. 5. In the following description, in order to distinguish the own game apparatus from the another game apparatus, the own game apparatus is referred to as “game apparatus 10a”, and the another game apparatus is referred to as “game apparatus 10b”. Further, a player of the game apparatus 10a is referred to as “player A”, and a player of the game apparatus 10b is referred to as “player B”.

The “other player information” includes player identification data, appearance data, and facility designation data. The player identification data is data for identifying the player, and may be a player's name registered in the game apparatus 10b by the player B, or a player character's name registered in the game apparatus 10b by the player B, or a player identification code that is automatically and randomly determined by the game apparatus 10b when the player B starts the game on the game apparatus 10b. The appearance data and the facility designation data are data registered in the game apparatus 10b by the player B, and will be described later in detail.

As for timing at which the game apparatus 10a receives the “other player information” from the game apparatus 10b, various timings are considered. For example, the timings may include: when an online match play is performed between the game apparatus 10a and the game apparatus 10b; when exchange of virtual creatures is performed between the game apparatus 10a and the game apparatus 10b; when transmission/reception of an e-mail is performed between the game apparatus 10a and the game apparatus 10b; and when a beacon signal (including the “other player information”) that is periodically broadcast by the game apparatus 10b is received by the game apparatus 10a.

Simultaneously with the reception of the “other player information” from the game apparatus 10b, the game apparatus 10a may transmit similar information to the game apparatus 10b.

When the game apparatus 10a receives the “other player information” from the game apparatus 10b, a passerby corresponding to the player B appears in the shopping center in the game world of the game apparatus 10a, as shown in FIG. 6. The appearance of the passerby is determined based on the appearance data included in the “other player information” received from the game apparatus 10b.

If the game apparatus 10a receives a plurality of pieces of “other player information” from a plurality of other game apparatuses, a plurality of passersby corresponding to the respective other game apparatuses appear in the shopping center.

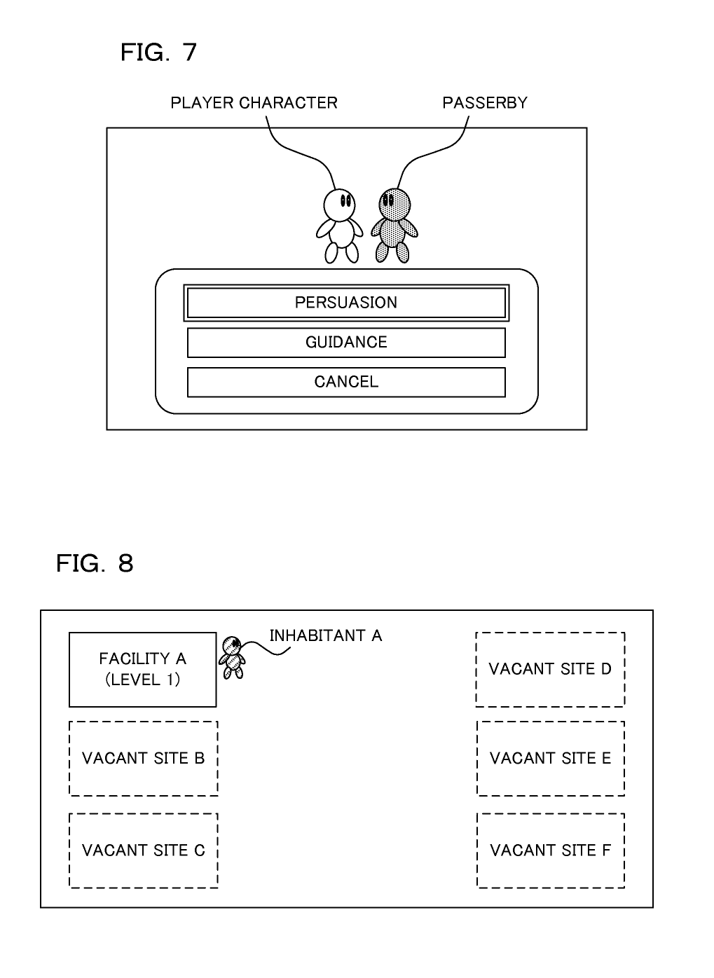

When the player A controls the player character to talk to the passerby appearing in the shopping center, a plurality of options (persuasion, guidance, and cancel) are presented as shown in FIG. 7. When the player A selects “persuasion”, the player character persuades the passerby to run a facility in the shopping center. As a result, as shown in FIG. 8, a facility (facility A) is created in any of the vacant sites in the shopping center (in FIG. 8, vacant site A), and the persuaded passerby becomes to run the facility as an inhabitant of the facility (inhabitant A).

Eight types of facilities, such as “dojo”, “nursery school”, “variety store”, and “flower shop”, are prepared as facilities created in the shopping center. The “dojo” and the “nursery school” are facilities (training facilities) in which virtual friend creatures can be trained for a fee (i.e., in exchange for currency in the game world or medals that the virtual friend creatures have won by defeating virtual enemy creatures). The “variety store” and the “flower shop” are facilities in which the virtual creatures can purchase goods and nuts to be used in the game world, respectively.

Which facility, among the eight types of facilities, is created when the passerby is “persuaded” is determined based on a predetermined rule. Specifically, it is determined based on the “other player information” received from the game apparatus 10b. That is, if any of the facilities is designated by the facility designation data included in the received “other player information”, the designated facility is created. On the other hand, if none of the facilities is designated by the facility designation data included in the received “other player information” or when facility designation data is not included in the received “other player information”, a facility to be created is determined based on the player identification data included in the received “other player information” (e.g., based on a value of a remainder when the value of the player identification data is divided by 8). A facility to be created may be determined by a drawing using random numbers.

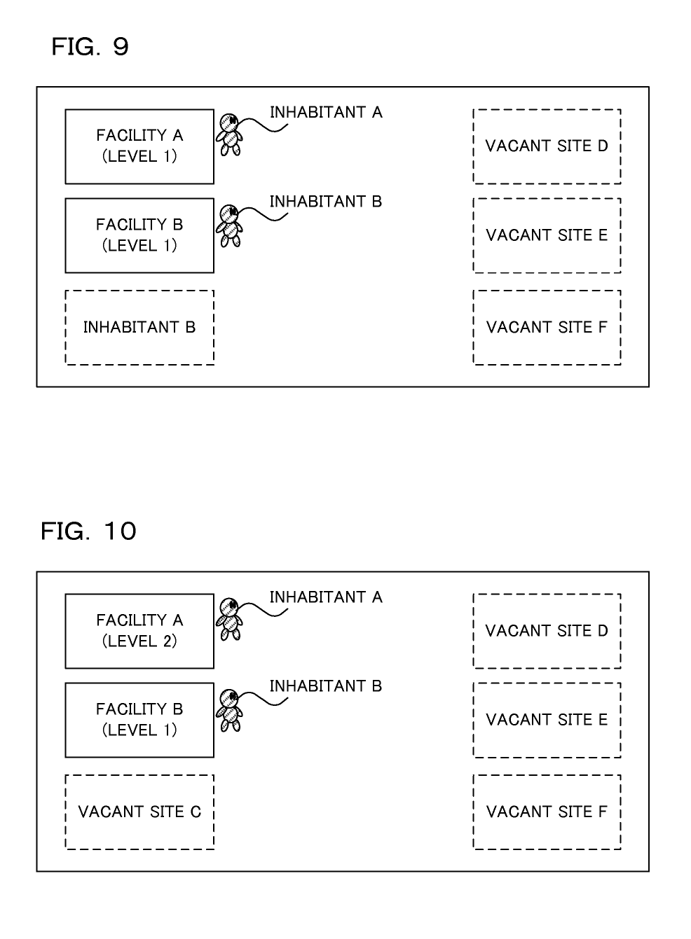

As described above, a passerby can be caused to appear in the shopping center by receiving the “other player information” from another game apparatus, and then a facility can be created in the shopping center by “persuading” the passerby. By receiving “other player information” from still another game apparatus and repeating the same procedure as above, it is possible to create a new facility (facility B) in the shopping center as shown in FIG. 9, and thus the shopping center is developed.

If the player character talks to a passerby that appears in the shopping center in which one or more facilities have already been present and then the player A selects “guidance” (refer to FIG. 7), the player character guides the passerby to any of the facilities in the shopping center. If the passerby likes the facility to which the passerby is guided by the player character, and utilizes the facility, the facility is developed. Each “level” shown in FIGS. 8 to 10 is an index indicating the degree of development of the corresponding facility. For example, the level of the facility A is “1” in FIGS. 8 and 9. However, when a passerby is guided to the facility A and utilizes the facility A, the level of the facility A is raised to “2” as shown in FIG. 10. When the level of the facility is raised, the appearance of the facility becomes gorgeous, the kinds of services (or commodities) provided by the facility are increased, and/or the qualities (or effects) of the services (or commodities) provided by the facility are improved. For example, if the level of the “dojo” as a training facility is raised, the kinds of abilities that can be enhanced (e.g., level, physical strength, offensive power, defensive power, quickness, etc.) are increased, and/or the degree of enhancement of each ability is increased.

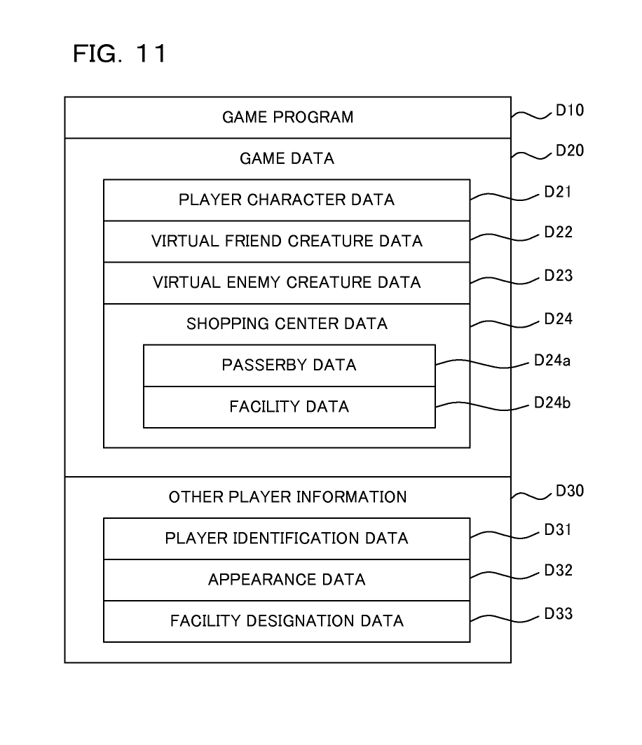

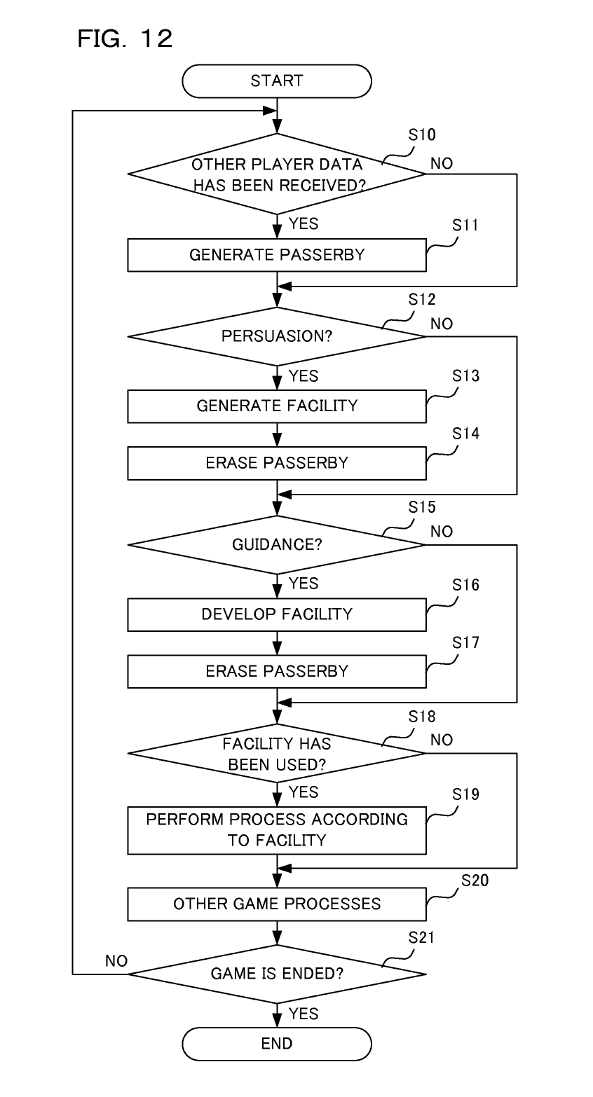

Next, the operation of the game apparatus 10 will be described in more detail with reference to FIGS. 11 and 12.

FIG. 11 shows examples of a computer program and data stored in the main memory 15 of the game apparatus 10.

A game program D10 is a computer program for causing the processor 13 to execute the above-described game (a role playing game or a character training (raising) game). The game program D10 is read from the internal storage device 14 or an external storage device (e.g., a game cartridge) which is not shown, and is loaded into the main memory 15. The game program D10 may be received from another game apparatus or a server device via the communication device 16, and loaded into the main memory 15.

Game data D20 is data utilized when executing the game program D10. The game data D20 includes player character data D21, virtual friend creature data D22, virtual enemy creature data D23, shopping center data D24, and the like.

The player character data D21 is data relating to a player character in the game world, and includes: data indicating the name of the player character; data indicating the position of the player character in the game world; data of goods, nuts, and the like owned by the player character; data indicating the appearance of the player character; and the like.

The virtual friend creature data D22 is data relating to a virtual friend creature owned by the player character, and includes: data indicating the type of the virtual friend creature owned by the player character; parameters indicating various abilities of the virtual friend creature (e.g., level, physical strength, offensive power, defensive power, quickness, etc.); and the like.

The virtual enemy creature data D23 is data relating to a virtual enemy creature, and includes: parameters indicating various abilities of the virtual enemy creature (e.g., level, physical strength, offensive power, defensive power, quickness, etc.); and the like.

The shopping center data D24 is data relating to the above-described shopping center, and includes: passerby data D24a relating to passersby that appear in the shopping center; facility data D24b relating to facilities creased in the shopping center; and the like. The passerby data D24a includes: data indicating the position of each passerby; data indicating the name of each passerby; data indicating the appearance of each passerby; and the like. The facility data D24b includes: data indicating the position of each facility; data indicating the type of each facility; data indicating the level of each facility; data indicating the kinds of services (or commodities) provided by each facility; and the like.

Other player information D30 is the above-described “other player information” received from another game apparatus. As described above, the other player information D30 includes the player identification data D31, appearance data D32, facility designation data D33, and the like.

The following will describe a procedure of game processing executed by the processor 13 of the game apparatus 10 based on the game program D10, with reference to the flowchart of FIG. 12.

When execution of the game program D10 is started, firstly, in step S10 in FIG. 12, the processor 13 determines whether other player information D30 has been received from another game apparatus via the communication device 16. Upon determining that other player information D30 has been received, the process goes to step S11, and otherwise, the process goes to step S12.

In step S11, the processor 13 causes a new passerby in the shopping center in the game world, based on the other player information D30 (i.e., the processor 13 updates the passerby data D24a).

In step S12, the processor 13 determines whether the player has selected “persuasion” (refer to FIG. 7). Upon determining that “persuasion” has been selected, the process goes to step S13, and otherwise, the process goes to step S15.

In step S13, the processor 13 causes a new facility to appear in the shopping center (i.e., the processor 13 updates the facility data D24b). The type of the facility is determined based on the other player information D30 corresponding to the passerby persuaded by the player character, as described above.

In step S14, the processor 13 erases the passerby persuaded by the player character from the shopping center (i.e., the processor 13 updates the passerby data D24a). Since the erased passerby becomes an inhabitant of the newly appearing facility, information such as the name, appearance, and the like of the passerby is stored as inhabitant data in the facility data D24b.

In step S15, the processor 13 determines whether “guidance” (refer to FIG. 7) has been selected by the player. Upon determining that “guidance” has been selected, the process goes to step S16, and otherwise, the process goes to step S18.

In step S16, the processor 13 develops the facility to which the passerby is guided by the player character (i.e., the processor 13 updates the facility data D24b). The processor 13 may determine whether the passerby likes the facility, and may develop the facility only when the passerby likes the facility.

In step S17, the processor 13 erases, from the shopping center, the passerby that has been guided to any facility by the player character (i.e., the processor 13 updates the passerby data D24a). With this, the other player information D30 corresponding to the erased passerby may be erased from the main memory 15.

In step S18, the processor 13 determines whether the player character has utilized any facility in the shopping center (e.g., whether, after the player character has talked to the inhabitant of any facility, the player has selected any service or commodity provided by the facility). Upon determining that any facility has been utilized, the process goes to step S19, and otherwise, the process goes to step S20.

In step S19, the processor 13 performs a process according to the facility utilized by the player character. For example, when the training facility is utilized, the ability of the virtual friend creature owned by the player character is enhanced in exchange for the currency or the like in the game world, which is possessed by the player character (generally, predetermined points given to the player while the player plays the game). In this case, the player character data D21 and the virtual friend creature data D22 are updated. On the other hand, when the “variety store” or the like is utilized, the player character gets a commodity in exchange for the currency or the like in the game world, which is possessed by the player character. In this case, the player character data D21 is updated.

In step S20, the processor 13 performs other game processes. Specifically, the processor 13 performs: a process of controlling the player character, based on an input from the input device 11; a process of selecting a command, based on an input from the input device 11; a process of causing the virtual friend creature and the virtual enemy creature to fight, based on an input from the input device 11; a process of enhancing the ability of the virtual friend creature in accordance with the result of the fight with the virtual enemy creature (i.e., a process of updating the virtual friend creature data D22); a process of generating a game image, based on the game data D20; and the like. These processes are general game processes, and therefore, are not described in detail here.

In step S21, the processor 13 determines whether the game is ended. Upon determining that the game is ended, the processor 13 ends the execution of the game program D10. Otherwise, the process returns to step S10, and the above-described series of process steps are repeated.

As described above, according to the present embodiment, since a new facility becomes available in the shopping center, on a requirement that a game apparatus communicates with another game apparatus (or receives a signal broadcast by another game apparatus), a player of the game apparatus is motivated to communicate with the another game apparatus, and thereby communication between the game apparatuses can be activated. In particular, since a training facility becomes available which performs, on behalf of the player, “training (raising) of a character” that is a fundamentally important factor in a role playing game or a training game, the player is greatly motivated to communicate with the another game apparatus. Further, for a player who is not good at training a character in the usual game play (e.g., enhancing the ability of a virtual friend creature by causing the friend creature to repeatedly win fights with virtual enemy creatures), it is possible to give such a player a chance to train the character by a method different from the usual game play (i.e., so-called “loophole”).

Further, since the type of the newly created facility depends on the received “other player information” (or the result of random drawing), the player needs to communicate with basically multiple other game apparatuses in order to cause a desired facility to appear. Thereby, communication between the game apparatuses can be more activated.

Since the currency or the like in the game world is needed to utilize the training facility, it is possible to prevent the game balance from deteriorating due to abuse of the training facility.

The embodiment described above is merely one embodiment, and various modifications are considered.

For example, in the above embodiment, the plurality of processes shown in FIG. 12 are executed by one computer (processor 13). However, in another embodiment, these processes may be executed by a plurality of computers in a shared manner. In still another embodiment, a part or the entirety of these processes may be implemented by a dedicated circuit.

Further, in the above embodiment, the plurality of processes shown in FIG. 12 are executed on one information processing apparatus (game apparatus 10). However, in another embodiment, these processes may be executed by a plurality of information processing apparatuses (e.g., the game apparatus 10 and the server apparatus) in a shared manner.

What is claimed is:

1. A non-transitory computer-readable storage medium having stored therein a game program for causing a computer of an information processing apparatus connected to an input device and a communication device to execute:
a first training process of training a game character in a game world, based on an operation performed by a player on the input device;
a reception process of receiving predetermined data from an information processing apparatus of another player via the communication device; and
a training support process of activating a substitute training function capable of training the game character without depending on the first training process, or enhancing efficiency of training by the first training process, on at least a requirement that the predetermined data has been received by the reception process.

2. The non-transitory computer-readable storage medium according to claim 1, wherein
the training support process includes:
a substitute training function activating process of activating the substitute training function capable of training the game character without depending on the first training process, on at least a requirement that the predetermined data has been received by the reception process; and
a second training process of training the game character by the substitute training function.

3. The non-transitory computer-readable storage medium according to claim 2, wherein
in the substitute training function activating process, the substitute training function is activated by causing a training facility capable of training the game character without depending on the first training process to appear in the game world.

4. The non-transitory computer-readable storage medium according to claim 2, wherein
the game program causes the computer to further execute a point giving process of giving predetermined points to the player in accordance with an operation performed by the player on the input device, and
in the second training process, the game character is trained by the substitute training function in exchange for a predetermined number of points given to the player by the point giving process.

5. The non-transitory computer-readable storage medium according to claim 2, wherein
the substitute training function activating process includes a determination process of determining, based on a predetermined rule, whether the substitute training function is to be activated, in response to that the predetermined data has been received by the reception process, and
in the substitute training function activating process, the substitute training function is activated only when a result of the determination of the determination process is positive.

6. The non-transitory computer-readable storage medium according to claim 5, wherein
in the determination process, whether the substitute training function is to be activated is determined based on the predetermined data received by the reception process.

7. The non-transitory computer-readable storage medium according to claim 6, wherein
the predetermined data includes function designation data that designates a function selected by the another player from among a plurality of functions including the substitute training function and other functions, and
in the determination process, the substitute training function is activated only when the function designation data included in the predetermined data designates the substitute training function.

8. The non-transitory computer-readable storage medium according to claim 2, wherein
the game program causes the computer to further execute a substitute training function development process of developing the substitute training function, on at least a requirement that the predetermined data has been received from an information processing apparatus of still another player by the reception process, in a state where the substitute training function has already been activated by the substitute training function activating process.

9. A game apparatus connected to an input device and a communication device, the game apparatus comprising:
a first training section configured to train a game character in a game world in accordance with an operation performed by a player on the input device;
a reception section configured to receive predetermined data from an information processing apparatus of another player via the communication device; and
a training support section configured to activate a substitute training function capable of training the game character without depending on the first training section, or enhance efficiency of training by the first training section, on at least a requirement that the predetermined data has been received by the reception unit.

10. A game system comprising:
an input device;
a communication device;
a first training section configured to train a game character in a game world in accordance with an operation performed by a player on the input device;
a reception section configured to receive predetermined data from an information processing apparatus of another player via the communication device; and
a training support section configured to activate a substitute training function capable of training the game character without depending on the first training section, or enhance efficiency of training by the first training section, on at least a requirement that the predetermined data has been received by the reception section.

11. A game processing method executed in an information processing apparatus connected to an input device and a communication device, the method comprising:
executing a first training process of training a game character in a game world in accordance with an operation performed by a player on the input device;
executing a reception process of receiving predetermined data from an information processing apparatus of another player via the communication device; and
executing a training support process of activating a substitute training function capable of training the game character without depending on the first training process, or enhancing efficiency of training by the first training process, on at least a requirement that the predetermined data has been received by the reception process.
